(19) United States
(12) Patent Application Publication
(10) Pub. No.: US 2024/0217031 A1
(43) Pub. Date: Jul. 4, 2024

(54) METHOD AND DEVICE FOR LASER PROCESSING A WORKPIECE

(71) Applicant: TRUMPF Laser- und Systemtechnik GmbH, Ditzingen (DE)

(72) Inventors: Daniel Flamm, Ludwigsburg (DE); Myriam Kaiser, Heimsheim (DE); Jonas Kleiner, Leonberg (DE)

(21) Appl. No.: 18/603,278

(22) Filed: Mar. 13, 2024

Related U.S. Application Data
(63) Continuation of application No. PCT/EP2022/074994, filed on Sep. 8, 2022.

(30) Foreign Application Priority Data
Sep. 16, 2021 (DE) 10 2021 123 962.1

(51) Int. Cl. B23K 26/06; B23K 26/067; B23K 26/352

(52) U.S. Cl. CPC B23K 26/0648; B23K 26/067; B23K 26/352

(57) ABSTRACT

A method for laser processing a workpiece is provided. The workpiece includes a transparent material. The method includes splitting an input laser beam into a plurality of partial beams using a beam splitter, focusing the plurality of partial beams coupled out of the beam splitter to form multiple focus elements, and subjecting the material of the workpiece to the multiple focus elements for laser processing. A distance between adjacent focus elements is at least 3 μm and/or at most 70 μm.

### CROSS REFERENCE TO RELATED APPLICATIONS

This application is a continuation of International Application No. PCT/EP2022/074994 (WO 2023/041417 A1), filed on Sep. 8, 2022, and claims benefit to German Patent Application No. DE 10 2021 123 962.1, filed on Sep. 16, 2021. The aforementioned applications are hereby incorporated by reference herein.

### FIELD

Embodiments of the present invention relate to a method for laser processing a workpiece. Embodiments of the present invention also relate to a device for laser processing a workpiece.

### BACKGROUND

A diffractive optical beam forming element for applying a phase profile to a laser beam provided for laser processing a material substantially transparent to the laser beam using a phase mask is known from DE 10 2014 116 958 A1, which is formed for applying a plurality of beam forming phase profiles to the laser beam incident on the phase mask, wherein at least one of the plurality of beam forming phase profiles is assigned a virtual optical image, which can be imaged in at least one elongated focus zone to form a modification in the material to be processed.

A method for severing a transparent material by means of a drawn-out focal zone of a laser beam is known from EP 3 597 353 A1.

A method for severing and in particular beveling a transparent material is known from JP 2020 004 889 A, wherein a plurality of focal points for laser processing the material are generated by means of a spatial light modulator.

Methods for forming a beveled edge area on a transparent material by means of a laser beam are known from US 2020/0147729 A1 and US 2020/0361037 A1.

A method for severing a transparent material by means of multiple parallel nondiffractive laser beams is known from WO 2016/089799 A1.

### SUMMARY

Embodiments of the present invention provide a method for laser processing a workpiece. The workpiece includes a transparent material. The method includes splitting an input laser beam into a plurality of partial beams using a beam splitter, focusing the plurality of partial beams coupled out of the beam splitter to form multiple focus elements, and subjecting the material of the workpiece to the multiple focus elements for laser processing. A distance between adjacent focus elements is at least 3 μm and/or at most 70 μm.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of one exemplary embodiment of a device for laser processing a workpiece;

FIG. 2 shows a schematic cross-sectional view of a section of a material of the workpiece, in which the material is subjected to multiple focus elements for laser processing, according to some embodiments;

FIG. 3 shows a schematic cross-sectional view of a section of the workpiece in which material modifications, which are accompanied by a crack formation of the material, were produced by subjecting the workpiece to focus elements, according to some embodiments;

FIG. 4a shows a cross-sectional view of a simulated intensity distribution of focus elements for laser processing the workpiece, wherein mutually adjacent focus elements are each spaced apart at a distance of approximately 17.5 μm, according to some embodiments;

FIG. 4b shows a cross-sectional view of a simulated intensity distribution of focus elements for laser processing the workpiece, wherein mutually adjacent focus elements are each spaced apart at a distance of approximately 8.0 μm, according to some embodiments;

FIG. 5a shows a schematic perspective view of a workpiece having material modifications formed thereon, which extend along a processing line and/or processing surface, according to some embodiments;

FIG. 5b shows a schematic perspective view of two workpiece segments, which are formed by severing the workpiece according to FIG. 4a along the processing line and/or processing surface, according to some embodiments;

FIG. 6a shows a microscope picture of a section of a severing surface formed by severing the material of the workpiece, wherein the distance between mutually adjacent focus elements, by means of which the material was processed at the severing surface, is approximately 7.0 μm, according to some embodiments;

FIG. 6b shows a height profile measured along line A-A according to FIG. 6a, according to some embodiments;

FIG. 6c shows a microscope picture of a section of a severing surface formed by severing the material of the workpiece, wherein the distance between mutually adjacent focus elements by means of which the material was processed at the severing surface is approximately 25.0 μm, according to some embodiments; and

FIG. 6d shows a height profile measured along line B-B according to FIG. 6c, according to some embodiments.

### DETAILED DESCRIPTION

Embodiments of the invention provide a method to form material modifications in the material of a workpiece which enable severing of the material with a severing surface which has a reduced roughness.

In the method, an input laser beam is split by means of a beam splitting element into a plurality of partial beams, partial beams decoupled from the beam splitting element are focused, wherein multiple focus elements are formed by focusing of the partial beams, and in which the material of the workpiece is subjected to laser processing with the focus elements. A distance between mutually adjacent focus elements is at least 3 μm and/or at most 70 μm.

During the laser processing of the workpiece by means of the method according to embodiments of the invention, material modifications are formed in the material of the workpiece which in particular enable severing of the material. It has been shown that the roughness of the severing surface resulting upon severing of the material is dependent on the distance of the mutually adjacent focus elements or the distance of the material modifications formed by means of these focus elements. Upon selection of this distance in the specified range, the severing surface may be implemented having a low roughness and/or great smoothness. An increased edge stability of the material of the workpiece at the severing surface results therefrom.

By subjecting the material of the workpiece to the focus elements, material modifications are formed which are arranged in the material at positions and/or distances corresponding to the focus elements. In particular, the distance of the mutually adjacent focus elements corresponds to a distance of mutually adjacent material modifications, which are formed by means of these focus elements in the material of the workpiece. It has been shown that the material modifications formed in the material having the distance or distance range according to embodiments of the invention enable advantageous severing of the material.

Due to the distance according to embodiments of the invention of the material modifications, a good ability to etch the material for its severing results. In particular, the formation of material modifications having the mentioned distance results in a partial overlap of adjacent material modifications, due to which an etching connection results. Moreover, material modifications in the mentioned distance are also advantageous in the case of a thermal severing of the material, since adjacent material modifications then in particular have a crack connection.

If a distance of the mutually adjacent focus elements becomes too small, undesired interference effects between adjacent focus elements can result therefrom, which can have the consequence, for example, of beat effects in the intensity of the focus elements. This can obstruct an ability to control the formation of the material modifications and in particular obstruct a formation of identical material modifications.

In particular, the focus elements which are formed by focusing the partial beams are to be understood as those focus elements to which the material is subjected for laser processing, and/or which are introduced into the material for laser processing.

In particular, the focus elements formed are each arranged at different spatial positions. The spatial position of a specific focus element is to be understood in particular as a center point position of the corresponding focus element.

In particular, the distance of the mutually adjacent focus elements is to be understood as a distance of the respective center point positions of the focus elements. In particular, the distance of the focus elements is to be understood as their distance within the material of the workpiece.

In particular, it can be provided that the focus elements are moved relative to the material of the workpiece at a feed speed for laser processing of the workpiece. The focus elements preferably lie in a plane, which is oriented in particular perpendicular to the feed direction. In particular, all focus elements formed lie in this plane.

It can be advantageous if the distance between mutually adjacent focus elements is at most 50 μm and in particular at most 30 μm.

It can be advantageous if the distance between mutually adjacent focus elements is at least 5 μm and/or at most 10 μm. A severing of the material having a severing surface may thus be implemented which has a low roughness and/or a good smoothness.

For example, multiple mutually adjacent focus elements are provided, which are each spaced apart from one another at least approximately at an equal distance. It can be provided that all focus elements provided for laser processing of the workpiece are spaced apart from one another at the same distance.

In particular, it can be provided that splitting of the input laser beam by means of the beam splitting element is performed by phase application to a beam cross section of the input laser beam or comprises a phase application to a beam cross section of the input laser beam. The focus elements may thus be formed, for example, as copies of one another. In particular, the focus elements may thus be introduced in a technically simple manner at different positions and/or with different distances into the material of the workpiece.

It can be provided that the splitting of the input laser beam is exclusively performed by phase application to the beam cross section of the input laser beam.

In particular, the phase application takes place in the transverse direction of the input laser beam. The transverse direction lies in a plane oriented perpendicularly to the direction of beam propagation of the input laser beam.

Alternatively or additionally, it can be provided that splitting of the input laser beam by means of the beam splitting element is performed by polarization beam splitting or comprises polarization beam splitting. For example, mutually adjacent focus elements may then each be formed having different polarization states. In particular interference of mutually adjacent focus elements can thus be prevented. Mutually adjacent focus elements may thus be arranged, for example, at a small distance from one another.

It is possible in principle that the splitting of the input laser beam is performed both by means of phase application and by means of polarization beam splitting.

In particular, it can be provided that the distance of the mutually adjacent focus elements has a nonzero distance component, which is oriented parallel to a thickness direction of the workpiece. In particular, the respective distance of all adjacent focus elements which are provided for laser processing of the workpiece has a nonzero distance component which is oriented parallel to the thickness direction of the workpiece.

In particular, the distance component parallel to the thickness direction has a value which is greater than zero in absolute value.

The thickness direction of the workpiece is to be understood in particular as a direction which is oriented transversely and in particular perpendicularly to an outer side of the workpiece, by which the focus elements and/or a laser beam for forming the focus elements are coupled into the material.

In particular, it can be provided that the distance of the mutually adjacent focus elements has a nonzero distance component which is oriented parallel to a beam propagation direction of a laser beam from which the focus elements are formed. In particular, the respective distance between all adjacent focus elements which are provided for laser processing of the workpiece has this nonzero distance component.

In particular, it can be provided that focus elements different from one another are arranged along a predetermined processing line, and that by subjecting the material of the workpiece to these focus elements in the material of the workpiece along the processing line, material modifications are formed which in particular enable a severing of the material.

In particular, the focus elements are spaced apart along the processing line and/or have an intensity such that the material modifications formed by means of the focus elements along the processing line enable a severing of the material.

An edge geometry and/or a cross-sectional geometry of a severing surface arising due to severing of the material may be defined by means of the processing line. In particular, a shape of the processing line corresponds to a shape and/or cross-sectional shape of the severing surface formed by severing of the material.

For example, the at least one processing line has a total length of between 50 μm and 5000 μm and preferably between 100 μm and 1000 μm. Workpieces having a thickness in the mentioned range may thus be processed and in particular severed.

The material of the workpiece has, for example, a thickness between 50 μm and 5000 μm and preferably between 100 μm and 1000 μm, for example approximately 500 μm.

In particular, it can be provided that the processing line is formed spatially continuous over a thickness of the material of the workpiece and/or over a thickness of a workpiece segment to be severed from the workpiece.

The processing line is not necessarily formed spatially coherent, but can have different spatially severed sections. In particular, the processing line can have gaps and/or interruptions in which no focus elements are arranged.

In particular, the processing line is or comprises a connecting line between mutually adjacent focus elements.

In particular, it can be provided that at least a subset of the mutually adjacent focus elements, which are assigned to the processing line, have a nonzero distance component which is oriented parallel to a first spatial direction, and have a nonzero further distance component which is oriented perpendicular to the first spatial direction. The first spatial direction is in particular a thickness direction of the workpiece and/or a beam propagation direction and in particular a main beam propagation direction of a laser beam, from which the focus elements are formed.

It can be favorable if at least 3 and/or at most 30 focus elements are arranged per 100 μm length of the processing line. In particular, at least 10 and/or at most 20 focus elements are arranged per 100 μm length of the processing line. Material modifications are thus formed in the material of the workpiece, which are spaced apart at a distance of at least 3 μm and/or at most 70 μm, in particular at least 5 μm and/or at most 10 μm. The severing surface having low roughness and/or great smoothness may thus be implemented upon severing of the material.

In particular, it can be provided that an angle of attack between the processing line and an outer side of the workpiece, through which the focus elements for laser processing are coupled into the material of the workpiece, is at least 1° and/or at most 90° at least in some sections, and is in particular at most 89°. Depending on the selection of the angle of attack, for example, a perpendicular cut may thus be executed on the workpiece or the workpiece may be chamfered at a specific angle.

The processing line having a specific angle of attack or angle of attack range at least in some sections is to be understood in particular to mean that the processing line has at least one section having this angle of attack or angle of attack range.

In particular, the angle of attack can be at least 10° and/or at most 80°, preferably at least 30° and/or at most 60°, preferably at least 40° and/or at most 50°.

In particular, it can be provided that the angle of attack of the processing line is constant at least in sections, and/or that the processing line has multiple sections having different angles of attack.

In particular, it can be provided that the processing line is a straight line at least in sections, and/or that the processing line is a curve at least in sections.

By embodying the processing line as a curve, for example, rounded segments may be severed from the workpiece. For example, rounded edges may thus be created.

If the processing line is embodied as a curve, the processing line is, for example, assigned a specific angle of attack range, which the processing line has with respect to the outer side of the workpiece.

In particular, it can be provided that the processing line is moved with the focus elements for laser processing of the workpiece relative to the workpiece in a feed direction, wherein the processing line is in a plane oriented perpendicular to the feed direction. In particular a processing surface corresponding to the processing line is thus formed, along which material modifications are arranged and/or along which the material of the workpiece can be severed.

In particular, it can be provided that the material of the workpiece can be severed or is severed after completed laser processing, wherein it can be provided in particular that the material can be severed or is severed at a processing surface, at which material modifications were formed by means of the laser processing.

In particular, it can be provided that the material of the workpiece can be severed or is severed by exerting a thermal impingement and/or a mechanical tension and/or by etching by means of at least one wet-chemical solution. For example, the etching takes place in an ultrasound-assisted etching bath.

The material modifications introduced into transparent materials by ultrashort laser pulses are divided into three different classes; see K. Itoh et al. “Ultrafast Processes for Bulk Modification of Transparent Materials” MRS Bulletin, vol. 31, p. 620 (2006): Type I is an isotropic refractive index change; type II is a birefringent refractive index change; and type III is what is known as a void or cavity. In this respect, the material modification created depends on laser parameters of the laser beam forming the focus element, such as e.g. the pulse duration, the wavelength, the pulse energy and the repetition frequency of the laser beam, and on the material properties, such as, among other things, the electronic structure and the coefficient of thermal expansion, and also on the numerical aperture (NA) of the focusing.

The type I isotropic refractive index changes are traced back to locally restricted fusing by way of the laser pulses and fast resolidification of the transparent material. For example, quartz glass has a higher density and refractive index of the material if the quartz glass is cooled quickly from a higher temperature. Thus, if the material in the focal volume melts and subsequently cools down quickly, then the quartz glass has a higher refractive index in the regions of the material modification than in the non-modified regions.

The type II birefringent refractive index changes may arise, for example, due to interference between the ultrashort laser pulse and the electric field of the plasma generated by the laser pulses. This interference leads to periodic modulations in the electron plasma density, which leads to a birefringent property, which is to say directionally dependent refractive indices, of the transparent material upon solidification. A type II modification is, for example, also accompanied by the formation of what are known as nanogratings.

By way of example, the voids (cavities) of the type III modifications can be produced using a high laser pulse energy. In this context, the formation of the voids is ascribed to an explosion-like expansion of highly excited, vaporized material from the focal volume into the surrounding material. This process is also referred to as a micro-explosion. Since this expansion occurs within the mass of the material, the micro-explosion leaves behind a less dense or hollow core (the void), or a microscopic defect in the sub-micrometer range or in the atomic range, which void or defect is surrounded by a compacted material envelope. Stresses which can result in spontaneous cracking or which can promote cracking arise in the transparent material due to the compaction at the shock front of the micro-explosion.

In particular, the formation of voids may also be accompanied by type I and type II modifications. By way of example, type I and type II modifications can arise in the less stressed areas around the introduced laser pulses. Accordingly, if reference is made to the introduction of a type III modification, then a less dense or hollow core or a defect is present in any case. By way of example, it is not a cavity but a region of lower density that is produced in sapphire by the micro-explosion of the type III modification. Due to the material stresses that arise in the case of a type III modification, such a modification moreover often is accompanied by, or at least promotes, a formation of cracks. The formation of type I and type II modifications cannot be completely suppressed or avoided when type III modifications are introduced. Finding “pure” type III modifications is therefore unlikely.

At high repetition rates of the laser beam, the material cannot cool down completely between the pulses, so that cumulative effects of the heat introduced from pulse to pulse can influence the material modification. By way of example, the repetition frequency of the laser beam can be higher than the reciprocal of the thermal diffusion time of the material, with the result that heat accumulation as a result of successive absorption of laser energy can occur in the focus elements until the melting temperature of the material has been reached. Moreover, a region larger than the focus elements can be fused by the thermal transport of the thermal energy into the areas surrounding the focus elements. The heated material cools quickly following the introduction of ultrashort laser pulses, and so the density and other structural properties of the high-temperature state are, as it were, frozen in the material.

It can be advantageous if material modifications are formed in the material by subjecting the material of the workpiece to the focus elements, wherein the material modifications are accompanied by cracking of the material, and/or wherein the material modifications are type III material modifications. In particular, severing of the material may be implemented by means of these material modifications.

It can be favorable if material modifications are formed in the material by subjecting the material of the workpiece to the focus elements, wherein the material modifications are accompanied by a change of a refractive index of the material, and/or wherein the material modifications are type I material modifications and/or type II material modifications. In particular, severing of the material may be implemented by means of these material modifications.

A transparent material is to be understood to mean in particular a material through which at least 70% and in particular at least 80% and in particular at least 90% of a laser energy of a laser beam from which the focus elements are formed is transmitted.

In particular, the input laser beam and/or a laser beam from which the focus elements are formed is a pulsed laser beam and in particular an ultrashort pulse laser beam. By subjecting the material to the focus elements, in particular laser pulses and in particular ultrashort laser pulses are thus introduced into the material.

In particular, the input laser beam and/or a laser beam from which the focus elements are formed has a diffracting beam profile and/or a Gaussian beam profile.

For example, a wavelength of the input laser beam and/or of the laser beam from which the focus elements are formed is at least 300 nm and/or at most 1500 nm. For example, the wavelength is 515 nm or 1030 nm.

In particular, the input laser beam and/or the laser beam from which the focus elements are formed has an average power of at least 1 W to 1 kW. For example, the laser beam comprises pulses having a pulse energy of at least 10 μJ and/or at most 50 μJ. It can be provided that the laser beam comprises individual pulses or bursts, wherein the bursts have 2 to 20 subpulses and in particular a time interval of approximately 20 ns.

A focus element is to be understood in particular as a radiation area having a specific spatial extension. To determine spatial dimensions of a specific focus element, such as a diameter of the focus element, only intensity values above a specific intensity threshold are considered. In this respect, the intensity threshold is selected, for example, such that values below this intensity threshold have such a low intensity that they are no longer relevant for interaction with the material for the purpose of forming material modifications. For example, the intensity threshold is 50% of a global intensity maximum of the focus element.

In particular, a specific focus element is assigned a respective spatial region of interaction, in which the focus element interacts with the material of the workpiece when it is introduced into this material.

In particular, the focus elements introduced into the material interact with the material by nonlinear absorption. In particular, material modifications are formed in the material due to nonlinear absorption by means of the focus elements.

In particular, the focus elements have a diffracting beam profile. In particular, the focusing elements are formed diffraction-limited.

For example, a specific focus element has a Gaussian shape and/or a Gaussian intensity profile.

In particular, it can be provided that the respective focus elements according to the preceding definition have a maximum spatial extension of at least 0.5 μm and/or at most 30 μm, preferably at least 2 μm and/or at most 10 μm. In particular, a maximum spatial extension of a region of interaction assigned to a specific focus element with the material of the workpiece is at least 0.5 μm and/or at most 30 μm, and preferably at least 2 μm and/or at most 10 μm.

The maximum spatial extension of a specific focus element is to be understood in particular as the greatest spatial extension of the focus element in an arbitrary spatial direction.

In particular, a respective maximum spatial extension of the focus elements is less than 20% and preferably less than 10% and preferably less than 5% of a thickness of the material.

Embodiments of the invention also relate to a device for laser processing a workpiece. The device includes a beam splitting element for splitting an input laser beam into a plurality of partial beams, and a focusing optical unit for focusing partial beams decoupled from the beam splitting element, wherein multiple focus elements for laser processing the workpiece are formed by focusing the partial beams. A distance between mutually adjacent focus elements is at least 3 μm and/or at most 70 μm.

In particular, the device according to embodiments of the invention has one or more further features and/or advantages of the method according to embodiments of the invention.

In particular, the method according to embodiments of the invention can be carried out by means of the device according to embodiments of the invention, or the method according to embodiments of the invention is carried out by means of the device according to embodiments of the invention.

In particular, it can be provided that the distance between mutually adjacent focus elements is at least 5 μm and/or at most 10 μm.

In particular, the beam splitting element and/or the focusing optical unit is configured to form focus elements having the mentioned distance or distance range.

It can be advantageous if the beam splitting element is formed as a 3D beam splitting element or comprises a 3D beam splitting element. It can then be provided that the splitting of the input laser beam is performed by phase application to a beam cross section of the input laser beam and in particular exclusively by phase application to the beam cross section of the input laser beam.

It can be favorable if the beam splitting element is formed as a polarization beam splitting element or comprises a polarization beam splitting element.

For example, the beam splitting element comprises multiple components and/or functionalities. It can be provided that the beam splitting element comprises both a 3D beam splitting element and a polarization beam splitting element.

In particular, the device comprises a laser source for providing the input laser beam, wherein the input laser beam is in particular a pulsed laser beam and/or an ultrashort pulse laser beam.

In particular, the specifications “at least approximately” or “approximately” should be understood to mean in general a deviation of at most 10%. Unless stated otherwise, the specifications “at least approximately” or “approximately” are to be understood to mean in particular that an actual value and/or distance and/or angle deviates by no more than 10% from an ideal value and/or distance and/or angle.

The following description of preferred embodiments serves to explain the invention in greater detail in association with the drawings.

Elements which are the same or have equivalent functions are provided with the same reference signs in all of the figures.

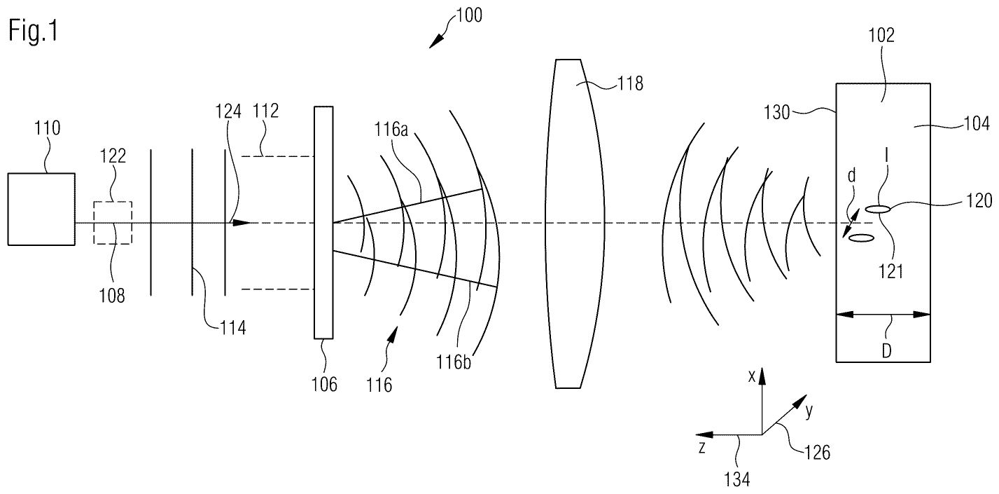

One exemplary embodiment of a device for laser processing a workpiece is shown in FIG. 1 and designated therein by 100. Localized material modifications, such as defects in the sub-micrometer range or atomic range, which result in material weakening, may be produced by means of the device 100 in a material 102 of the workpiece 104. The workpiece 104 can be severed at these material modifications. By way of example, by means of the material modifications formed, a workpiece segment can be severed from the workpiece 104.

In particular, material modifications may be introduced at an angle of attack into the material 102 by means of the device 100, so that an edge area of the workpiece 104 may be chamfered or beveled by severing a corresponding workpiece segment from the workpiece 104.

The device comprises a beam splitting element 106, into which an input laser beam 108 is coupled. This input laser beam 108 is provided, for example, by means of a laser source 110. The input laser beam 108 is, for example, a pulsed laser beam and/or an ultrashort pulse laser beam.

In particular, the input laser beam 108 is to be understood as a beam bundle which comprises a plurality of beams extending in parallel in particular. The input laser beam 108 in particular has a transverse beam cross section 112 and/or a transverse beam extension, with which the input laser beam 108 is incident on the beam splitting element 106.

The input laser beam 108 incident on the beam splitting element 106 in particular has at least approximately planar wavefronts 114.

The input laser beam 108 is split by means of the beam splitting element 106 into a plurality of partial beams 116 and/or partial beam bundles. In the example shown in FIG. 1, two different partial beams 116a and 116b are indicated.

The partial beams 116 or partial beam bundles decoupled from the beam splitting element 106 in particular have a divergent beam profile. In particular, the beam splitting element 106 is formed as a far field beam forming element.

To focus the partial beams 116 decoupled from the beam splitting element 106, the device 100 comprises a focusing optical unit 118, into which the partial beams 116 are coupled. The focusing optical unit 118 has one or more lens elements, for example. By way of example, the focusing optical unit 118 is formed as a microscope objective.

For example, the beam splitting element 106 is at least approximately arranged in a rear focal plane of the focusing optical unit 118.

The focusing optical unit 118 has, for example, a focal length between 5 mm and 50 mm.

In particular, mutually different partial beams 116 are incident on the focusing optical unit 118 with a position offset and/or angular offset.

The partial beams 116 are focused by means of the focusing optical unit 118, so that multiple focus elements 120 are formed, which are each arranged at different spatial positions. It is possible in principle that mutually adjacent focus elements spatially overlap in sections.

For example, one or more partial beams 116 and/or partial beam bundles are each assigned to a specific focus element 120. For example, a respective focus element 120 is formed by focusing one or more partial beams 116 and/or partial beam bundles.

A focus element 120 is to be understood in particular as a focused radiation area, such as a focus spot and/or a focus point. In particular, the focus elements 120 each have a specific geometric shape and/or a specific intensity profile, wherein the geometric shape is to be understood, for example, as a spatial shape and/or a spatial extension of the respective focus element 120.

The geometric shape and/or the intensity profile of a specific focus element 120 is designated hereinafter as the focus distribution 121 of the focus element 120. The focus distribution 121 is a property of the respective focus elements 120 and describes their respective shape and/or intensity profile. In particular, multiple focus elements 120 or all focus elements 120 formed have the same focus distribution.

The focus distribution of the focus elements 120 formed is defined by the input laser beam 108, the splitting of which by means of the beam splitting element 106 forms the focus elements 120. If the input laser beam 108 were focused before being coupled into the beam splitting element 106, a single focus element would thus be formed having the focus distribution assigned to the input laser beam 108.

For example, the input laser beam 108, if it is provided, for example, by means of the laser source 110, has a Gaussian beam profile. By focusing the input laser beam 108, a focus element would be formed in this case which has a focus distribution having Gaussian shape and/or Gaussian intensity profile.

Alternatively thereto, for example, it can be provided that a Bessel-like beam profile is assigned to the input laser beam 108, so that by focusing the input laser beam 108, a focus element would be formed which has a focus distribution having Bessel-like shape and/or Bessel-like intensity profile.

The focus distribution of the input laser beam 108 is assigned to the partial beams 116 and/or partial beam bundles formed by splitting the input laser beam 108 by means of the beam splitting element 106 such that by focusing the partial beams 116, the focus elements 120 are formed having this focus distribution and/or having a focus distribution based on this focus distribution.

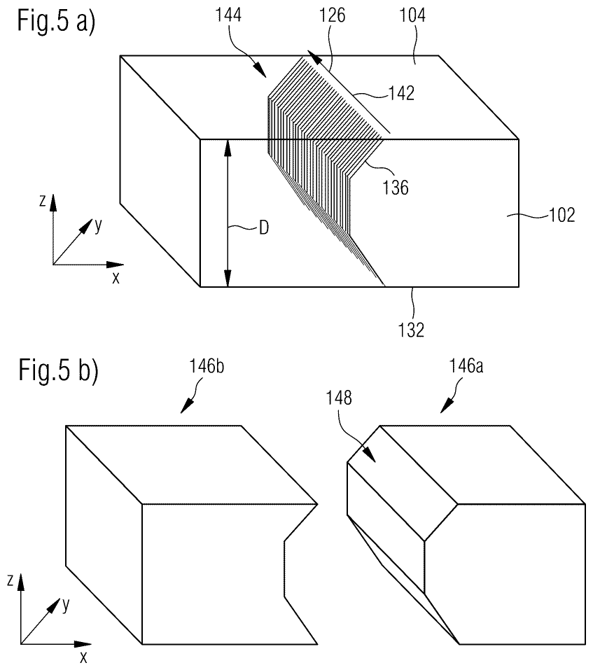

In the example shown in FIG. 1, the input laser beam 108 has a Gaussian beam profile, i.e., a focus distribution having Gaussian shape and/or Gaussian intensity profile is assigned to the input laser beam 108. The focus elements 120 then each, for example, have the focus distribution 121 having this Gaussian shape and/or this Gaussian intensity profile or having a shape and/or intensity profile based on this Gaussian shape and/or this Gaussian intensity profile (cf. also FIGS. 5a and 5b).

If, for example, a Bessel-like beam profile is assigned to the input laser beam 108, the focus elements 120 formed for laser processing the workpiece 104 each have a focus distribution 121 having this Bessel-like beam profile or having a beam profile based on this Bessel-like profile. The focus elements 120 may thus each be formed, for example, having a focus distribution which has an elongated shape and/or an elongated intensity profile.

It can be provided that the device 100 has a beam forming device 122 for beam forming of the input laser beam 108 (indicated in FIG. 1). For example, this beam forming device 122 is arranged in front of the beam splitting element 106 and/or between the laser source 110 and the beam splitting element 106 with respect to a beam propagation direction 124 of the input laser beam 108.

A beam propagation direction is to be understood in particular as a main beam propagation direction and/or an average propagation direction of laser beams.

A specific focus distribution and/or a specific beam profile may be assigned in particular to the input laser beam 108 by means of the beam forming device 122. In particular, the focus distribution 121 of the focus elements 120 may be defined by means of the beam forming device 122.

The beam forming device 122 can be configured, for example, to form a laser beam having quasi-non-diffracting and/or Bessel-like beam profile from a laser beam having Gaussian beam profile. The input laser beam 108 coupled into the beam splitting element 106 then has the quasi-non-diffracting and/or Bessel-like beam profile. The focus elements 120 then accordingly also have this quasi-non-diffracting and/or Bessel-like beam profile or a beam profile based on this beam profile.

With regard to the definition and the implementation of quasi-non-diffracting and/or Bessel-like beams, reference is made to the book: “Structured Light Fields: Applications in Optical Trapping, Manipulation and Organisation”, M. Wördemann, Springer Science & Business Media (2012), ISBN 978-3-642-29322-1, and also to the scientific publications “Bessel-like optical beams with arbitrary trajectories” by I. Chremmos et al., Optics Letters, Vol. 37, No. 23, Dec. 1, 2012 and “Generalized axicon-based generation of nondiffracting beams” by K. Chen et al., arXiv: 1911.03103v1 [physics.optics], Nov. 8, 2019.

The focus elements 120 are in particular each formed identically to one another and/or each formed as copies of one another by beam splitting by means of the beam splitting element 106.

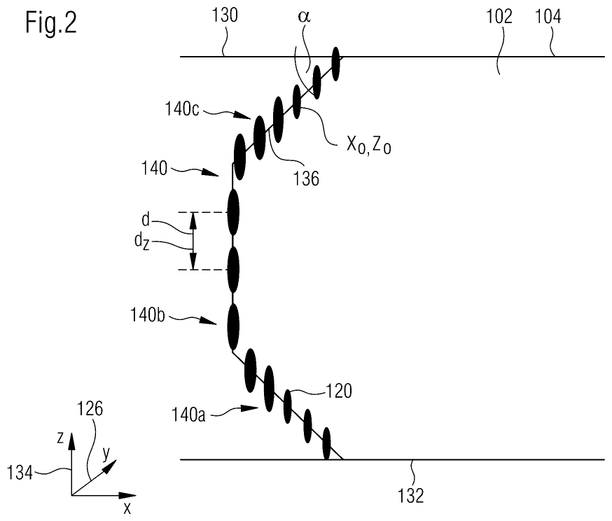

A specific local position x₀, z₀ is assigned to each of the focus elements 120 formed, at which a respective focus element 120 is arranged with respect to the material 102 of the workpiece 104 (FIG. 2). For example, the local position of a focus element 120 is to be understood as the position of its spatial center point and/or focal point.

Furthermore, a specific intensity I is in particular assigned to each of the focus elements 120 formed. Both the local position x₀, z₀ and in particular also the intensity I of the respective focus elements 120 may be defined by means of the beam splitting element 106.

In particular, several or all focus elements 120 formed for laser processing the workpiece 104 have the same intensity I. However, it is also possible that several of the focus elements 120 formed have different intensities I.

In particular, a respective distance d and/or a respective position offset between mutually adjacent focus elements 120 can be set by means of the beam splitting element 106. A distance direction of the distance d settable by means of the beam splitting element 106 preferably lies in a plane which is oriented transversely and in particular perpendicularly to a feed direction 126, in which the focus elements 120 are moved relative to the workpiece 104 for laser processing the workpiece 104. For example, the distance d is settable by means of the beam splitting element 106 by component in two spatial directions, which span the mentioned plane or lie in the mentioned plane (x direction and z direction in the example shown in FIG. 1).

The beam splitting element 106 is preferably formed as a 3D beam splitting element or comprises a 3D beam splitting element. The focus elements 120 may thus be formed, for example, such that they are each identical to one another and/or that they each represent copies of one another.

With respect to the technical implementation and properties of the beam splitting element 106 designed as a 3D beam splitting element, reference is made to the scientific publication “Structured light for ultrafast laser micro- and nanoprocessing” by D. Flamm et al., arXiv:2012.10119v1 [physics.optics], Dec. 18, 2020. Full explicit reference is made thereto.

To carry out the beam splitting, in one embodiment of the beam splitting element 106, in which the beam splitting element 106 is designed, for example, as a 3D beam splitting element, a defined transverse phase distribution is applied to the transverse beam cross section 112 of the input laser beam 108. A transverse beam cross section or a transverse phase distribution is to be understood in particular as a beam cross section or a phase distribution in a plane oriented transversely and in particular perpendicularly to the beam propagation direction 124 of the input laser beam 108.

The focus elements 120 are formed by interference of the focus partial beams 116, wherein, for example, constructive interference, destructive interference, or intermediate cases thereof can occur, such as partial constructive or destructive interference.

To form the focus elements 120 at the respective position x₀, z₀ and/or having the respective distance d, the phase distribution applied by means of the beam splitting element 106 has a specific optical grating component and/or optical lens component for each focus element 120.

Due to the optical grating component, after focusing of the partial beams 116, a corresponding position offset of the focus elements 120 formed results in a first spatial direction, for example in the x direction. Due to the optical lens component, partial beams 116 or partial beam bundles are incident at different angles or with different convergence or divergence on the focusing optical unit 118, which results after completed focusing in a position offset in a second spatial direction, for example in the z direction.

The intensity I of the respective focus elements 120 is determined by phases of the focused partial beams 116 in relation to one another. These phases are definable by the mentioned optical grating components and optical lens components. The phases of the focused partial beams 116 can be selected in relation to one another in the design of the beam splitting element 106 so that the focus elements 120 each have a desired intensity.

Alternatively or additionally, it can be provided that the beam splitting element 106 is formed as a polarization beam splitting element or comprises a polarization beam splitting element. In this case, polarization beam splitting of the input laser beam 108 into beams which each have one of at least two different polarization states is carried out by means of the beam splitting element 106.

In particular, the aforementioned polarization states should be understood to mean linear polarization states, in which case for example two different polarization states are provided and/or polarization states oriented perpendicularly to one another are provided.

In particular, the polarization states are such that an electric field is oriented in a plane perpendicular to the beam propagation direction of the polarized beams (transverse electric).

For the polarization beam splitting, the beam splitting element 106 comprises, for example, a birefringent lens element and/or a birefringent wedge element. For example, the birefringent lens element and/or the birefringent wedge element are produced from a quartz crystal or comprise a quartz crystal.

With regard to the mode of operation and embodiment of the beam splitting element 106 as a polarization beam splitting element, reference is made to the German patent application with the reference number 10 2020 207 715.0 (filing date: Jun. 22, 2020), in the name of the same applicant, and to DE 10 2019 217 577 A1.

In particular, the partial beams 116 may be formed having different polarization states by the polarization beam splitting. The focus elements 120 may each be formed from beams having a specific polarization state by focusing these partial beams 116 by means of the focusing optical unit 118. A specific polarization state may thus be assigned to each of the focus elements 120.

Focus elements 120, which are each arranged at specific positions x₀, z₀, may be formed by means of polarization beam splitting, wherein mutually adjacent focus elements are each spaced apart at the distance d.

In particular, the focus elements 120 may be arranged and formed by polarization beam splitting by means of the beam splitting element 106 so that mutually adjacent focus elements 120 each have different polarization states.

For the laser processing of the workpiece 104, the focus elements 120 are introduced into the material 102 of the workpiece 104 and moved relative to the material 102 in the feed direction 126, wherein the focus elements 120 are moved in particular at a specific feed speed in the feed direction 126. In the example shown, the feed direction 126 corresponds to the y direction.

A specific local position x₀, z₀ is assigned to each of the focus elements 120 formed, at which a respective focus element 120 is arranged with respect to the material 102 of the workpiece 104.

In particular, the local positions x₀, z₀ of the respective focus elements 120 lie in a plane oriented perpendicular to the feed direction 126, wherein in particular all focus elements 120 formed for laser processing the workpiece 104 lie in this plane. For example, center points and/or focal points of the focus elements 120 and in particular all focus elements 120 are each arranged in the mentioned plane.

The coupling in of the focus elements 120, which are introduced into the material 102 for laser processing the workpiece 104, takes place, for example, through a first outer side 130 of the workpiece 104.

For example, the workpiece 104 is plate-shaped and/or panel-shaped. A second outer side 132 of the workpiece 104 is arranged, for example, spaced apart in the thickness direction 134 and/or depth direction of the workpiece 104 from the first outer side 130.

The material 102 of the workpiece 104 has, for example, an at least approximately constant thickness D in the thickness direction 134.

The feed direction 126 is oriented transversely and in particular perpendicularly to the thickness direction 134 of the workpiece 104.

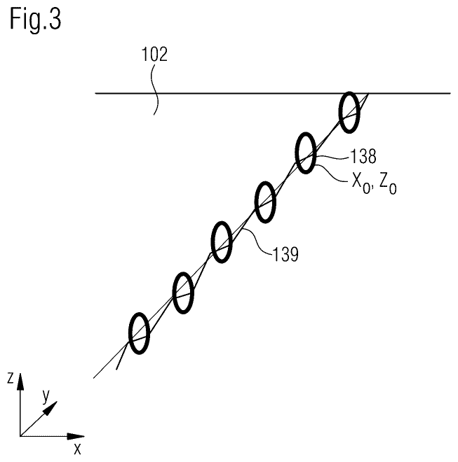

In particular, the focus elements 120 formed are arranged along a defined processing line 136. This processing line 136 corresponds to a desired processing geometry, using which the laser processing of the workpiece 104 is to be carried out. The respective distances d and intensities I of the focus elements 130 arranged along the processing line 136 are selected so that by subjecting the material 102 to these focus elements 120, material modifications 138 are formed (FIG. 3), which enable severing of the material along this processing line 136 and/or a processing surface corresponding to this processing line 136.

In particular, it can be provided that the processing line 136 extends between the first outer side 130 and the second outer side 132 and in particular continuously and/or without interruption between the first outer side 130 and the second outer side 132 of the workpiece 104.

It can be provided that the processing line 136 has multiple different sections 140. For example, in the example shown in FIG. 2, the processing line 136 has a first section 140a, a second section 140b, and a third section 140c, wherein, with respect to the thickness direction 134, the second section 140b adjoins the first section 140a and the third section 140c adjoins the second section 140b.

The processing line 136 is not necessarily formed continuously and/or differentiably. For example, the processing line 136 can have irregularities. It can be provided that the processing line 136 has interruptions and/or gaps, at which in particular no focus elements 120 are arranged.

The processing line 136 and/or different sections 140 of the processing line 136 can be formed, for example, as a straight line or curve.

It is provided that the respective distance d of adjacent focus elements 120, which are arranged along the processing line 136, is between 3 μm and 70 μm, preferably between 5 μm and 10 μm.

The respective distance d of the focus elements 120 provided for laser processing the workpiece 104 can be selected differently for different focus elements 120 and/or different pairs of focus elements 120. However, it is also possible in principle that the respective distance d is identical for all focus elements 120 provided for laser processing the workpiece 104.

For example, it can be provided that focus elements 120 having different distances d are respectively assigned to different sections 140 of the processing line. In particular, the respective distances d of the focus elements 120 assigned to a specific section 140 are then at least approximately constant.

In particular, a distance component d_{z} of the distance d oriented parallel to the thickness direction 134 of the material 102 is nonzero for all focus elements 120 and/or in all pairs of mutually adjacent focus elements 120. In particular, all adjacent focus elements 120 are spaced apart with a nonzero distance component d_{z} in the thickness direction 134.

Furthermore, the processing line 136 and/or the respective sections 140 of the processing line 136 is assigned a specific angle of attack α and/or angle of attack range, which the processing line 136 or the respective section 140 encloses with the first outer side 130 of the workpiece 104.

In the exemplary embodiment shown, the angle of attack α of the first section 140a and the third section 140c has an absolute value of 45° and that of the second section 140b of 90°.

By applying and/or introducing the focus elements 120 into the material 102, localized material modifications 138 are formed in each case, which are arranged at the respective local positions x₀, z₀ of the corresponding focus elements 120 in the material 102 (FIG. 3). By suitable selection of processing parameters, such as the respective distances d between the focus elements 120, their respective intensities I, the feed speed oriented in the feed direction 126, and the laser parameters of the input laser beam 108, the material modifications 146 can be formed, for example, as type III modifications, which are associated with a spontaneous formation of cracks 139 in the material 102 of the workpiece 104. In particular, cracks 139 are formed between mutually adjacent material modifications 146.

Alternatively thereto, it is also possible by suitable selection of the processing parameters to form the material modifications 146 as type I and/or type II modifications, which are accompanied by a heat accumulation in the material 102 and/or by a change of a refractive index of the material 102. The formation of the material modifications 146 as type I and/or type II modifications is associated with a heat accumulation in the material 102 of the workpiece 104. In particular, to form these material modifications 146, the respective distance d between the focus elements 120 is selected as sufficiently small that this heat accumulation occurs when the material 102 is subjected to the focus elements.

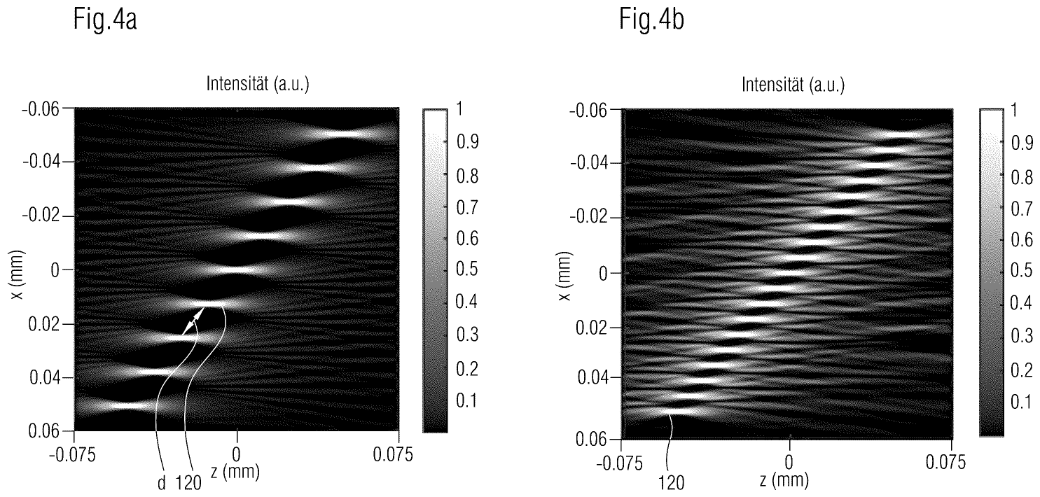

FIG. 4a shows a simulated intensity distribution of a plurality of focus elements 120, wherein the distance d is approximately 17.5 μm for these focus elements 120. In the grayscale value representation shown, brighter areas represent higher intensities.

FIG. 4b shows a simulated intensity distribution of a plurality of focus elements 120, wherein the distance d is approximately 8.0 μm.

The laser processing of the workpiece 104 by means of the device 100 functions as follows:

To carry out the laser processing, the material 102 of the workpiece 104 is subjected to the focus elements 120 and the focus elements 120 are moved in the feed direction 126 relative to the workpiece 104 through its material 102.

In this case, the material 102 is a material transparent to a wavelength of laser beams from which the focus elements 120 are each formed, such as a glass material. In the example shown, the focus elements are formed by beam forming of the input laser beam 108.

Material modifications 138, which are arranged along the processing line 136, are formed in the material 102 by subjecting the material 102 to the focus elements 120 (FIG. 5a). In the example shown in FIG. 5a, material modifications 138 are formed continuously over the entire thickness D of the material 102.

By relative movement of the focus elements 120 in relation to the material 102 along a predetermined trajectory 142, a processing surface 144 corresponding to the processing line 136 is formed, on which the material modifications 138 are arranged. A planar formation and/or arrangement of the material modifications 146 along the processing surface 152 thus results.

The trajectory 142 may in principle have straight and curved sections. In the case of curved sections, the processing line 136 is in particular turned during the laser processing so that it always lies in a plane oriented perpendicular to the feed direction 126. This can be implemented, for example, by corresponding rotation of the beam splitting element 106 or by relative rotation of the entire device 100 in relation to the workpiece 104.

A distance between adjacent material modifications 138 in the feed direction 126 may be defined, for example, by setting a pulse duration of the input laser beam 108 and/or by setting the feed speed.

The material modifications 146 formed along the processing line 136 result in particular in a reduction in a strength of the material 102. The material 102 may thus be severed after formation of the material modifications 146 at the processing surface 144, for example, by exerting a mechanical force, into two workpiece segments 146a and 146b different from one another (FIG. 5b).

The workpiece segment 146a in the example shown is a yield segment having a severing surface 148, which has a shape corresponding to the shape of the processing line 136. In this case, the workpiece segment 154a is a residual workpiece segment and/or scrap segment.

For example, the material 102 of the workpiece 104 is quartz glass. For example, to form the material modifications 138 as type I and/or type II modifications, a laser beam from which the focus elements 120 are formed has a wavelength of 1030 nm and a pulse duration of 1 ps. Furthermore, a numerical aperture assigned to the focusing optical unit 118 is then 0.4 and a pulse energy assigned to a single focus element 120 is then 50 to 200 nJ.

To form the material modifications 138 as type III modifications with otherwise unchanged parameters, the pulse energy assigned to a single focus element 120 is 500 to 2000 nJ.

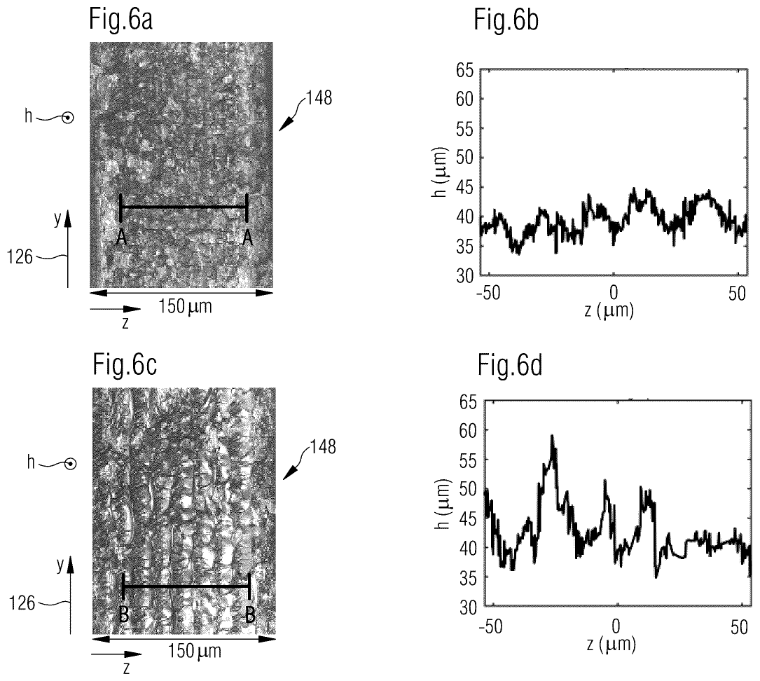

FIGS. 6a and 6c show microscope pictures of two different severing surfaces 148. In the examples shown, the material 102 was processed using focus elements 120, which were arranged along a processing line 136 extending in the z direction. The focus elements 120 were moved in the feed direction 126 (in the example shown in the y direction), so that material modifications 138 were formed at the processing surface 144 shown (z-y plane). The material 102 was then severed at this processing surface 144 by etching by means of a wet-chemical solution, so that the severing surface 148 shown was formed.

FIGS. 6b and 6d show height profiles of the severing surfaces 148 shown in FIGS. 6a and 6c, respectively, wherein a height direction h assigned to these height profiles is oriented perpendicular to the respective severing surface 148.

In the example shown in FIG. 6a, the distance d between the focus elements 120 was approximately 7.0 μm and in the example shown in FIG. 6b it was approximately 25.0 μm.

As can be seen clearly, the height profile shown in FIG. 6b has significantly smaller variations than the height profile according to FIG. 6d. The profile shown in FIG. 6d has clear outbursts.

For each of the severing surfaces 148 shown in FIGS. 6a and 6c, the roughness Ra was experimentally determined according to the norm ISO 25178, wherein the roughness Ra was determined over the entire severing surface (and not only on the basis of the height profiles shown in FIGS. 6b and 6d).

In the example according to FIGS. 6a and 6b, the roughness Ra is less than 2 μm, while in the example according to FIGS. 6c and 6d, the roughness is greater than 4 μm.

The roughness of the severing surface 148 may be reduced by suitable selection of the distance d between mutually adjacent focus elements. A smoother and/or flatter severing surface 148 may thus be implemented.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

α angle of attack
d distance
d_{z} distance component
D thickness
I intensity
x₀ position in the x direction
z₀ position in the y direction
100 device
102 material
104 workpiece
106 beam splitting element
108 input laser beam
110 laser source
112 beam cross section
114 wavefront
116 partial beams
116a partial beam
116b partial beam
118 focusing optical unit
120 focus element
121 focus distribution
122 beam forming device
124 beam propagation direction
126 feed direction
130 first outer side
132 second outer side
134 thickness direction
136 processing line
138 material modification
139 crack
140 section
140a first section
140b second section
140c third section
142 trajectory
144 processing surface
146a workpiece segment
146b workpiece segment
148 severing surface

1. A method for laser processing a workpiece, the workpiece comprising a transparent material, the method comprising:
splitting an input laser beam into a plurality of partial beams using a beam splitter,
focusing the plurality of partial beams coupled out of the beam splitter to form multiple focus elements, and
subjecting the material of the workpiece to the multiple focus elements for laser processing, wherein a distance between adjacent focus elements is at least 3 μm and/or at most 70 μm.

2. The method as claimed in claim 1, wherein the distance between adjacent focus elements is at least 5 μm and/or at most 10 μm.

3. The method as claimed in claim 1, wherein each pair of adjacent focus elements of multiple pairs of adjacent focus elements is spaced apart from one another at least approximately by an equal distance.

4. The method as claimed in claim 1, wherein the splitting of the input laser beam is comprises a phase application to a beam cross section of the input laser beam.

5. The method as claimed in claim 1, wherein the beam splitter comprises a polarization beam splitter.

6. The method as claimed in claim 1, wherein the distance between adjacent focus elements has a nonzero distance component oriented parallel to a thickness direction of the workpiece.

7. The method as claimed in claim 1, wherein the multiple focus elements are arranged along a predetermined processing line, and by subjecting the material of the workpiece to the multiple focus elements, material modifications are formed in the material of the workpiece along the processing line, thereby enabling severing of the material.

8. The method as claimed in claim 7, wherein at least a subset of the multiple focus elements have a first nonzero distance component oriented parallel to a thickness direction of the workpiece, and have a second nonzero distance component oriented perpendicular to the thickness direction of the workpiece.

9. The method as claimed in claim 7, wherein at least 3 and/or at most 30 focus elements are arranged per 100 μm length of the processing line.

10. The method as claimed in claim 7, wherein an angle of attack between the processing line and an outer side of the workpiece, through which the focus elements for laser processing are coupled into the material of the workpiece, is at least 1° and/or at most 90° at least in some sections.

11. The method as claimed in claim 7, wherein the processing line having the focus elements for laser processing of the workpiece is moved relative to the workpiece in a feed direction, wherein the processing line lies in a plane oriented perpendicular to the feed direction.

12. The method as claimed in claim 1, wherein material modifications are formed in the material by subjecting the material of the workpiece to the focus elements, wherein the material modifications are accompanied by a crack formation of the material.

13. The method as claimed in claim 12, wherein the material modifications are type III material modifications.

14. The method as claimed in claim 1, wherein material modifications are formed in the material by subjecting the material of the workpiece to the focus elements, wherein the material modifications are accompanied by a change of a refractive index of the material.

15. The method as claimed in claim 14, wherein the material modifications are type I material modifications and/or type II material modifications.

16. A device for laser processing a workpiece, the workpiece comprising a transparent material, the device comprising:
a beam splitter for splitting an input laser beam into a plurality of partial beams, and
a focusing optical unit for focusing the plurality of partial beams decoupled from the beam splitter to form multiple focus elements for laser processing of the workpiece, wherein a distance between adjacent focus elements is at least 3 μm and/or at most 70 μm.

17. The device as claimed in claim 16, wherein the beam splitter comprises a 3D beam splitter.

18. The device as claimed in claim 16, wherein the beam splitter comprises a polarization beam splitter.
